(19) United States
(12) Patent Application Publication
(10) Pub. No.: US 2010/0020471 A1
(43) Pub. Date: Jan. 28, 2010

(54) Electrode Device

(76) Inventor: Adrian Schneuwly, Schmitten (CH)

Correspondence Address: Maxwell Technologies, Inc. (OPLF), 9244 Balboa Avenue, San Diego, CA, 92123, US

(21) Appl. No.: 12/179,450

(22) Filed: Jul. 24, 2008

(51) Int. Cl. H01G 9/058; H01G 9/155

(52) U.S. Cl. 361/502; 29/25.03

(57) ABSTRACT

Electrodes, electrode devices, and methods of producing electrodes and electrode devices are disclosed. An exemplary method may comprise positioning a current collector adjacent to a first electrode and, optionally, a second electrode. The method may also comprise coupling the first electrode and optional second electrode. The current collector comprises a plurality of conductive protrusions extending into the first electrode and optional second electrode to reduce the ESR of the electrode device. The first electrode and optional second electrode may, for example, comprise electrode films. The method may be used to produce electrodes and electrode devices including, but not limited to, double-layer capacitor devices, batteries, and other energy storage devices.

### BACKGROUND

The present invention generally relates to electrode devices used in energy storage devices.

Electrode devices are widely used to store electrical energy, including primary (non-rechargeable) battery cells, secondary (rechargeable) battery cells, fuel cells, and capacitors. Important characteristics of these electrode devices include energy density, power density, maximum charging rate, internal leakage current, equivalent series resistance (ESR), and/or durability (i.e., the ability to withstand multiple charge-discharge cycles). For a number of reasons, double-layer capacitors, also known as “super-capacitors” and “ultra-capacitors,” are gaining popularity in many energy storage applications. The reasons include availability of double-layer capacitors with high power densities (in both charge and discharge modes), and with energy densities approaching those of conventional rechargeable cells.

Double-layer capacitors typically use electrodes immersed in an electrolyte (an electrolytic solution), as their energy storage element. As such, a porous separator immersed in and impregnated with the electrolyte may ensure that the electrodes do not come in contact with each other, preventing electronic current flow directly between the electrodes. At the same time, the porous separator allows ionic currents to flow through the electrolyte between the electrodes in both directions. As discussed below, compounds of charges are formed at the interfaces between the solid electrodes and the electrolyte.

When electric potential is applied between a pair of electrodes of a double-layer capacitor, ions that exist within the electrolyte are attracted to the surfaces of the oppositely-charged electrodes, and migrate towards the electrodes. A layer of oppositely-charged ions is thus created and maintained near each electrode surface. Electrical energy is stored in the charge separation layers between these ionic layers and the charge layers of the corresponding electrode surfaces. In fact, the charge separation layers behave essentially as electrostatic capacitors. Electrostatic energy can also be stored in the double-layer capacitors through orientation and alignment of molecules of the electrolytic solution under influence of the electric field induced by the potential. This mode of energy storage, however, is secondary.

In comparison to conventional capacitors, double-layer capacitors have high capacitance in relation to their volume and weight. There are two main reasons for these volumetric and weight efficiencies. First, the charge separation layers are very narrow. Their widths are typically on the order of nanometers. Second, the electrodes can be made from a porous material, having very large effective surface area per unit volume. Because capacitance is directly proportional to the electrode area and inversely proportional to the widths of the charge separation layers, the combined effect of the large effective surface area and narrow charge separation layers is capacitance that is very high in comparison to that of conventional capacitors of similar size and weight. High capacitance of double-layer capacitors allows the capacitors to receive, store, and release a large amount of electrical energy.

Another important performance parameter of a capacitor is its internal resistance. Frequency response of a capacitor depends on the characteristic time constant of the capacitor, which is essentially a product of the capacitance and the internal resistance, or RC. To put it differently, internal resistance limits both charge and discharge rates of a capacitor, because the resistance limits the current that flows into or out of the capacitor. Maximizing the charge and discharge rates is important in many applications. In automotive applications, for example, a capacitor that is used as the energy storage element that powers a vehicle's engine has to be able to provide high instantaneous power during acceleration, and to receive bursts of power produced by regenerative braking. In internal combustion-powered vehicles, the capacitor periodically powers a vehicle's starter, also requiring high power in relation to the size of the capacitor.

The internal resistance also creates heat during both charge and discharge cycles. Heat causes mechanical stresses and speeds up various chemical reactions, thereby accelerating capacitor aging. It is therefore desirable to reduce internal resistance of capacitors. Moreover, the energy converted into heat is lost, decreasing the efficiency of the capacitor.

Active materials used for electrode construction (e.g., activated carbon) usually have rather limited specific conductance. Thus, a large contact area may be desired to minimize the contact resistance between the electrode and its terminal. The active material may also be too brittle or otherwise unsuitable for directly connecting to terminals. Additionally, the material may have relatively low tensile strength, needing mechanical support in some applications. For these reasons, electrodes typically incorporate current collectors.

A current collector is typically a sheet of conductive material on which the active electrode is disposed, either directly or over one or more intermediate layers. Often, aluminum foil is used as the current collector material of a composite electrode. In one electrode fabrication process, a film that includes activated carbon powder (i.e., the active electrode) is produced, and then attached to a thin aluminum foil using an adhesive. The use of the adhesive improves bonding of the active electrode to the current collector.

### SUMMARY

Unfortunately, the use of adhesive to bond an active electrode to a current collector has a number of disadvantages. The adhesive increases the cost of materials consumed in the process of electrode fabrication; some adhesives are quite expensive. In addition, two steps are added to the fabrication process. The adhesive must be applied onto the current collector foil, or onto the active electrode film. The adhesive must also be allowed to dry and cure. These extra steps increase the cost of the final product. The adhesive may deteriorate with time, contributing to an increase in the internal resistance of the electrode. In some double-layer capacitors, for example, the electrolyte reacts chemically with the adhesive, causing the adhesive to weaken and the bond created by the adhesive to fail. Furthermore, adhesive use reduces the energy storage efficiency of the electrode, because the adhesive penetrates into the pores of the active electrode, decreasing the total surface active area of the electrode. Therefore, it would be preferable to reduce or eliminate the use of adhesives in compound electrodes.

Various implementations hereof are directed to electrodes, electrode devices, and methods of manufacturing/fabricating the same that may be directed to or may satisfy one or more of the above needs.

In one implementation, for example, an electrode material comprises a first electrode and a current collector disposed adjacent to and bonded to the first electrode. The current collector comprises a plurality of conductive protrusions extending in a z-direction from the current collector into the first electrode. The first electrode, for example, may comprise a first electrode film. The electrode material may also further comprise a second electrode (e.g., a second electrode film). In this implementation, the current collector is disposed between the first electrode and the second electrode. The current collector, in this implementation, for example may comprise a second plurality of conductive protrusions extending in the z-direction into the second electrode, opposite the first electrode. The current collector and the first or second electrode may be bonded without an adhesive, substantially without an adhesive, or with an adhesive. The current collector and the first or second electrode may be bonded by the application of pressure and/or heat. The electrode material may further comprise a non-conductive separator overlayed on the first electrode opposite the current collector. The electrode material may comprise an electrode of an energy storage device, such as a capacitor, a double-layer capacitor, or a battery.

In one implementation, the conductive protrusions comprise a plurality of conductive particles attached to a surface of the current collector. The conductive particles may be, for example, sprayed, deposited, or otherwise attached to the current collector.

In another implementation, the conductive protrusions comprise a plurality of needles or spikes extending from a surface of the current collector. In yet another implementation, the conductive protrusions comprise a plurality of deformations formed in the current collector. The deformations may be formed, for example, by embossing, punching or otherwise deforming the current collector.

In another implementation, a method for producing an electrode material is also provided. The method comprises positioning a current collector adjacent to a first electrode (e.g., a first electrode film). The current collector comprises a plurality of conductive protrusions extending in a z-direction from the current collector towards the first electrode. The current collector and first electrode are bonded, and the plurality of conductive protrusions extends from the current collector into the first electrode. In one implementation, the current collector is positioned between the first electrode and a second electrode (e.g., a second electrode film) and the current collector is bonded to the first electrode and the second electrode. A second plurality of conductive protrusions may extend from the current collector into the second electrode.

In one particular implementation, the operation of bonding is performed without an adhesive, substantially without an adhesive, or with an adhesive. The bonding operation may be performed, for example, by applying pressure and/or heat to the current collector and the first electrode. In another implementation, each operation is a dry operation. In yet another implementation, a separator film is positioned adjacent to the first electrode, opposite the current collector.

The current collector and the first electrode film may be rolled as part of a jelly-roll electrode structure of an energy storage device, such as a capacitor, a double-layer capacitor, or a battery. The rolled jelly-roll electrode structure may be placed into a container and electrically coupled to terminals of the energy storage device. The jelly-roll electrode structure may be impregnated with an electrolyte and sealed within the container to form the energy storage device.

In another implementation, a double-layer capacitor is provided comprising a current collector bonded to a first electrode material (e.g., a first electrode film). The current collector comprises a plurality of conductive protrusions extending from the current collector into the first electrode material.

In one particular implementation, the current collector is disposed between and bonded to the first electrode material and the second electrode material. In this implementation, the current collector comprises a second plurality of conductive protrusions extending from the current collector into the second electrode material.

The conductive protrusions of the current collector may comprise any number of conductive structures extending from a surface of the current collector. The conductive protrusions may, for example, comprise conductive particles attached to the current collector, spike or needle-like protrusions extending from the current collector, deformations formed in the current collector, or other conductive protrusions extending from the current collector.

The current collector and the first electrode material of the double-layer capacitor may be bonded without an adhesive, substantially without an adhesive, or with an adhesive.

### BRIEF DESCRIPTION OF THE DRAWINGS

FIGS. 1A and 1B are partially-exploded cross-sectional perspective views of exemplary electrodes.

FIG. 2A through and 2C are cross-sectional views of exemplary electrodes.

FIGS. 3A and 3B are side views illustrating a rolling process for manufacturing an exemplary electrode device from an electrode.

FIG. 4 is a flowchart illustrating exemplary process operations for producing an exemplary electrode.

### DETAILED DESCRIPTION

In this document, the words “implementation,” “embodiment,” and “variant” may be used to refer to a particular apparatus, process, or article of manufacture, and not necessarily always to one and the same apparatus, process, or article of manufacture. Thus, “one implementation” (or a similar expression) used in one place or context can refer to one particular apparatus, process, or article of manufacture; and, the same or a similar expression in a different place can refer either to the same or to a different apparatus, process, or article of manufacture. Similarly, “some implementations,” “certain implementations,” or similar expressions used in one place or context may refer to one or more particular apparatuses, processes, or articles of manufacture; the same or similar expressions in a different place or context may refer to the same or a different apparatus, process, or article of manufacture. The expression “alternative implementation” and similar phrases are used to indicate one of a number of different possible implementations. The number of possible implementations is not necessarily limited to two or any other quantity. Characterization of an implementation as “an exemplar” or “exemplary” means that the implementation is used as an example. Such characterization does not necessarily mean that the implementation is a preferred implementation; the implementation may but need not be a currently preferred implementation.

The meaning of the word “film” is similar to the meaning of the words “layer” and “sheet”; the word “film” does not necessarily imply a particular thickness or thinness of the material. The references to “binder” within this document are intended to convey the meaning of polymers, co-polymers, and similar ultra-high molecular weight substances capable of providing a binding for a material (e.g., activated carbon) therein. Such substances are often employed as binder for promoting cohesion in loosely-assembled particulate materials, i.e., active filler materials that perform some useful function in a particular application.

The words “calender,” “nip,” “laminator,” and similar expressions mean a device adapted for pressing and compressing. Pressing may be, but is not necessarily, performed using rollers. When used as verbs, “calender” and “laminate” mean processing in a press, which may, but need not, include rollers. Mixing or blending as used herein may mean processing which involves bringing together component elements into a mixture. High shear or high impact forces may be, but are not necessarily, used for such mixing. Example equipment that can be used to prepare/mix the various materials described herein may include, in non-limiting fashion: a ball mill, an electromagnetic ball mill, a disk mill, a pin mill, a high-energy impact mill, a fluid energy impact mill, an opposing nozzle jet mill, a fluidized bed jet mill, a hammer mill, a fritz mill, a Warring blender, a roll mill, a mechanofusion processor (e.g., a Hosokawa AMS), or an impact mill.

Other and further definitions and clarifications of definitions may be found throughout this document. The definitions are intended to assist in understanding this disclosure and the appended claims, but the scope and spirit of the invention should not be construed as strictly limited to the definitions, or to the particular examples described in this specification.

Reference will now be made in detail to several embodiments of the invention that are illustrated in the accompanying drawings. The same reference numerals are used in the drawings and the description to refer to the same or substantially the same parts or operations. The drawings are in simplified form and not to precise scale. For purposes of convenience and clarity only, directional terms, such as top, bottom, left, right, up, down, over, above, below, beneath, rear, and front may be used with respect to the accompanying drawings. These and similar directional terms, should not be construed to limit the scope of the invention.

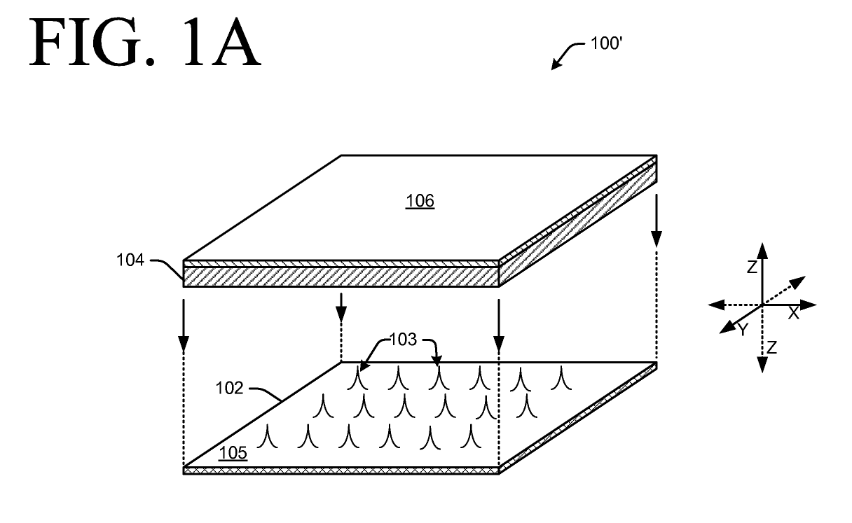

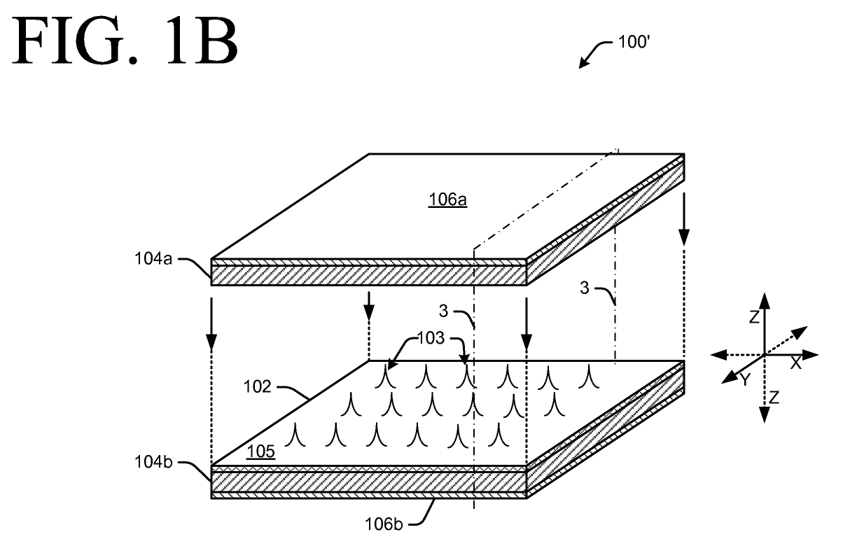

FIG. 1A is a partially-exploded cross-sectional perspective view of an exemplary electrode 100. The electrode 100 includes a current collector 102, and a film of active electrode film 104 disposed on one side of the current collector 102. Optionally, a noncurrent collector 106 may be applied the outer surface of the electrode film 104. The non-current collector 106, for example, may comprise a separator, an insulator (e.g., for insulating the electrode film 104, such as for use in a device) or other noncurrent collector material.

In an exemplary embodiment, the current collector 102 comprises a sheet of aluminum foil approximately 40 microns thick. It is noted, however, the current collector 102 is not limited to any particular size or configuration. In other exemplary embodiments, the thickness of the foil is between about 20 and about 100 microns; and in other, more specific embodiments, the thickness of the aluminum foil is between about 30 and about 50 microns. Still other embodiments are also contemplated. It is also noted that the current collector 102 is not limited to aluminum. Other conductive materials can be used for the current collector 102, such as, e.g., silver, copper, gold, platinum, and palladium, as well as various alloys of these and other metals.

The current collector 102 comprises a three-dimensional design in which a plurality of conductive protrusions 103 of the current collector 102 extends in a z-direction away from a surface 105 of the current collector 102. When the current collector 102 is combined with the active electrode film 104, the plurality of conductive protrusions 103 extend into the active electrode film 104. By extending a conductive surface of the current collector 102 into the active electrode film 104, an electron current path distance from within at least a portion of the active electrode film 104 to the current collector 102 is reduced, lowering the effective ESR of the electrode 100.

The conductive protrusions 103 may comprise any shape or form that extend into the active electrode film 104 when the current collector 102 is combined with the active electrode film 104. In one embodiment, for example, the conductive protrusions 103 of the current collector 102 include conductive particles attached to the surface 105 of the current collector 102. Aluminum or other conductive particles, for example, may be sprayed onto the surface 105 of the current collector 102. The particles, may be joined to current collector 102 in any method known in the art, such as but not limited to sputtering, spraying, deposition (e.g., chemical vapor deposition, plasma vapor deposition, or the like).

The particles, or other conductive structures disclosed as conductive protrusions in the various embodiments, may comprise varying sizes. In one embodiment, for example, the particles, or other conductive structures, may comprise particles or other structures from 1 micron to 50 microns in length in the z-direction. In another embodiment, for example, the particles, or other conductive structures, may comprise particles or other structures from 2 microns to 30 microns in length in the z-direction. In yet another embodiment, the particles, or other conductive structures, may comprise particles or other structures from 5 to 25 microns in length in the z-direction. In another embodiment, for example, the particles, or other conductive structures, may comprise particles or other structures from 10 microns to 25 microns in length in the z-direction. In yet another embodiment, the particles, or other conductive structures, may comprise particles or other structures from 15 to 20 microns in length in the z-direction. In another embodiment, for example, the particles, or other conductive structures, may comprise particles or other structures from 1 micron to 15 microns in length in the z-direction. In yet another embodiment, the particles, or other conductive structures, may comprise particles or other structures from 4 to 10 microns in length in the z-direction or from 5 microns to 7 microns in length in the z-direction. In another embodiment, the particles, or other conductive particles, may extend in the z-direction into the active electrode up to one-half the thickness of the active electrode, up to one-third the thickness of the active electrode, up to one-quarter the thickness of the active electrode, up to one-fifth the thickness of the active electrode, or up to one-eighth the thickness of the active electrode.

In another embodiment, for example, the conductive protrusions 103 comprise spikes or needles extending from the surface 105 of the current collector 102. In yet another embodiment, the conductive protrusions 103 comprise a portion of the current collector deformed to extend from the surface 105 of the current collector 102. Portions of the current collector 102 may be punched or otherwise deformed to extend from the surface 105 of the current collector.

The conductive protrusions 103 of the current collector 102 extend into the active electrode film 104. Accordingly, when the current collector 102 is positioned or combined with the electrode film 104, an interface is formed which electrically couples the electrode film 104 to the current collector 102.

Before continuing, however, it is noted that the current collector 102 may include any number, type, and/or configuration of conductive protrusions 103 extending from a surface 105 of the current collector 102.

FIG. 1B is a partially-exploded cross-sectional perspective view of another exemplary electrode 100′. The electrode 100′ includes a current collector 102, and a film of active electrode film 104a-b disposed on each side of the current collector 102. Optionally, a noncurrent collector 106a-b may be applied on one or both of the outer surfaces of the electrode film 104a-b, respectively. The non-current collector 106a-b, for example, may comprise a separator, an insulator (e.g., for insulating the electrode film 104a-b, such as for use in a device) or other noncurrent collector material.

The current collector 102 comprises a three-dimensional design in which a plurality of conductive protrusions 103 of the current collector 102 extends in a z-direction away from at least one surface 105 of the current collector 102. When the current collector 102 is combined with the active electrode films 104a-b, the plurality of conductive protrusions 103 extend into at least one of the active electrode films 104a-b. By extending a conductive surface of the current collector 102 into the active electrode films 104a-b, an electron current path distance from within at least a portion of the active electrode films 104a-b to the current collector 102 is reduced, lowering the effective ESR of the electrode 100′.

As described above with respect to FIG. 1A, the conductive protrusions 103 may comprise any shape or form that extends into at least one of the active electrode films 104a-b when the current collector 102 is combined with the active electrode films 104a-b.

The conductive protrusions 103 of the current collector 102 extend into at least one of the active electrode films 104a-b. Accordingly, when the current collector 102 is positioned or “sandwiched” between the upper electrode film 104a and the lower electrode film 104b, an interface is formed which electrically couples the upper electrode film 104a to a upper side of the current collector 102 and the lower electrode film 104b to a lower side of the current collector 102.

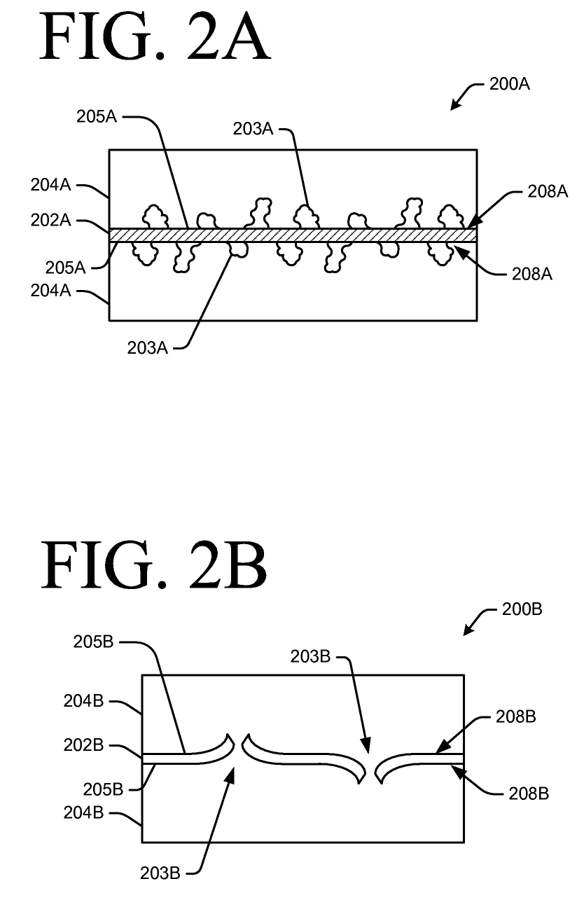

FIGS. 2A through 2C show exemplary embodiments of current collector 202A-C comprising three-dimensional designs in which a plurality of conductive protrusions 203A-C of the current collectors 202A-C extends in a z-direction away from at least one surface 205A-C of the current collector 202A-C. When the current collectors 202A-C are combined with active electrode films, the plurality of conductive protrusions 203A-C extend the active electrode films.

FIG. 2A, for example, shows one embodiment of a current collector 202A in which a plurality of conductive particles comprise conductive protrusions 203A extending in a z-direction away from surfaces 205 of the current collector 202A. The conductive protrusion 203A (comprising the conductive particles) extends into the active electrode films 204A-B.

The conductive particles may be attached to the surfaces 205 of the current collector in any manner allowing conduction from the particles to the current collector. Conductive particles may, for example, be sprayed, deposited, or otherwise attached to the surfaces 205 of the current collector 202A The conductive particles may also comprise any number of materials, such as aluminum, silver, copper, gold, platinum, and palladium, as well as various alloys of these and other metals. Where the current collector comprises one material (e.g., aluminum), the conductive particles may comprise the same or similar material to eliminate galvanization between the particles and the current collector that might increase the resistance between the particles and current collector and, correspondingly, the ESR of the electrode.

Interfaces 208A are formed between the current collector 202A and the active electrode films 204A-B and provide an electrical connection between current collector and active electrode films. The interfaces 208A may be connected with or without adhesive. In some embodiments, for example, the particles or other conductive protrusions may increase adhesion between the current collector and the active electrode such that the current collector and the active electrode may be adhered without adhesive or with a reduced amount of adhesive.

FIG. 2B shows another embodiment of a current collector 202B in which a plurality of conductive protrusions 203B extending in a z-direction away from surfaces 205 of the current collector 202B are formed by deforming the current collector 202B. The current collector 202B, for example, may be embossed, punched, or otherwise deformed to form the plurality of conductive protrusions 203B extending from the surfaces 205 of the current collector 202B. The deformations of the current collector 202B forming the conductive protrusion 203B extends into the active electrode films 204A-B.

Interfaces 208B are formed between the current collector 202B and the active electrode films 204A-B and provide an electrical connection between current collector and active electrode films.

FIG. 2C shows another embodiment of a current collector 202C in which a plurality of conductive protrusions 203C extending in a z-direction away from surfaces 205 of the current collector 202C are formed by needle-like conductive structures. The conductive protrusion 203C, comprising the needle-like conductive structures, extends into the active electrode films 204A-B.

The needle-like conductive structures may be formed by any method known in the art. In one embodiment, for example, conductive wire pieces (e.g., aluminum wire pieces) may be bonded, welded, resistively welded, or otherwise disposed onto the current collector. In another embodiment, needle-like or spike-like conductive particles may be formed or attached onto the current collector.

Interfaces 208C are formed between the current collector 202C and the active electrode films 204A-B and provide an electrical connection between current collector and active electrode films.

Still other sizes and shapes of conductive protrusions extending from a surface of the current collector are also contemplated and are not limited to those shown. Likewise, the conductive protrusions do not need to be evenly spaced across the surface of the current collector, as will be readily understood by those having ordinary skill in the art after becoming familiar with the teachings herein.

Before continuing, an exemplary active electrode film 104 will be described in detail so that the bonding process can be better understood. The electrode film 104 may include an active electrode material (e.g., activated carbon particles) and a binder for supporting the active electrode material within the film 104. The electrode film may also optionally include conductive particles (e.g., conductive carbon particles) and/or other additives. In an exemplary embodiment, the electrode film 104 comprises activated carbon particles, conductive carbon particles, and a binder, and has a volumetric porosity surface factor (VPSF) greater than about 7.5×10⁷ m⁻¹. The electrode film 104 may also have a porosity of between about 40 and 80%. In certain more specific embodiments, the porosity of the active electrode film 104 is between about 50 and about 70 percent, and the median pore size varies between about 1 and about 3 cubic micrometers. The term “porosity” as used herein means macroporosity (i.e., porosity on a large scale defined by the interstitial volume between particles).

The electrode film 104 may be manufactured using both known and novel processes. For example, the electrode film 104 may be manufactured using an extrusion process. The polymers used in accordance with the present invention include, but are not limited to polytetraflouroethylene (PTFE or Teflon®), polypropylene, polyethylene, co-polymers, and various polymer blends. The polymers act as a matrix for the active electrode material and within the electrode film 104.

To form the electrode film 104, powders of the polymer, the active electrode material, and possibly other powder materials may be dry-blended. In one exemplary embodiment, the powders and proportions used are as follows: 85-90 percent by weight of activated carbon (the “active electrode material”), 5-8 percent by weight of PTFE, and 2-10 percent by weight of conductive carbon (graphite, acting as a promoter of electrical conduction). Suitable activated carbon powders are available from a variety of sources, including Nuchar® powders sold by Westvaco Corporation (Stamford, Conn.). Another exemplary embodiment contains 85-93 percent of activated carbon, 3-8 percent of PTFE, and 2-10 percent of conductive carbon. Yet another exemplary embodiment contains activated carbon and PTFE, and does not use conductive carbon.

In any event, the resulting compound is introduced, together with a solvent, into an extruder to fibrillate the blended material, creating a dough-like film. In one embodiment, the proportion of the powder compound to the solvent is about 80/20 by weight. The dough-like substance may be calendered one or more times to produce a desired thickness and density. Finally, the dough-like substance is baked or otherwise dried to reduce the residual solvent to an acceptable level (e.g., on the order of parts per million) to produce the electrode film 104.

Another exemplary technique for manufacturing the electrode film 104 is disclosed in a co-pending, commonly-assigned U.S. patent application Ser. No. 10/817,701, filed Apr. 2, 2004, which is incorporated herein by reference. Still other techniques, now known or later developed, may also be implemented to manufacture the electrode film 104.

Having described exemplary embodiments for producing the electrode film 104, the bonding process to current collector 102 can now be explained again with reference to FIG. 1B, although one skilled in the art would readily appreciate that this discussion can be extrapolated for any of the embodiments shown in FIGS. 1A through 2C. In the exemplary embodiment of FIG. 1B, for example, the electrode film 104a and 104b may be bonded to the current collector 102 in a calender. That is, the current collector 102 is disposed (e.g., positioned or “sandwiched”) between opposing layers of the electrode film 104a-b and fed between rollers of the calender. The calender is gap-controlled, meaning that the gap between the rollers can be set to a predetermined distance to compresses the current collector 102 and electrode film 104a-b.

In an exemplary embodiment, the thickness of each layer of electrode film 104a and 104b is between about 160 and about 180 microns, and the thickness of the current collector 102 is about 40 microns. Accordingly, the gap of the calender may be set to between about 210 to about 220 microns. Because the current collector 102 is substantially uncompressible, the calender compresses the electrode film 104a-b by about 50 percent, forcing it onto the conductive protrusions 103 extending from the surfaces 105 of the current collector 102. Coming out of the calender, the electrode film 104a-b expands, so that the more permanent reduction in its thickness is between about 5 and about 20 percent.

Note that adhesive need not be applied to the surfaces of the current collector 102 or to the electrode film 104a-b, so that the interface 108 between the two surfaces is substantially free of adhesives and the impurities they may comprise. In some embodiments in accordance with the present invention, adhesion between these components results mostly from the pressure bond created by the calender. In other embodiments, however, in adhesion between these components may be due to a chemical reaction between layers of the electrode film 104a-b, and/or a combination of both mechanical interaction and chemical reaction of the layers of electrode film 104a-b.

Other processes for bonding the layers of electrode film 104a-b to one another at the interface 108 and to the current collector 102 may also be implemented. For example, pressure-controlled calenders may be used. To improve the pressure bond, one or both of the rollers of the calendar and/or the electrode film 104a-b and/or current collector 102 may be pre-heated. The speed with which the current collector 102 and the electrode film 104a-b move through the calender 205 may also be controlled. A person having ordinary skill in the art would recognize that any of a wide variety of other design parameters may also be implemented depending on the materials used, temperatures applied, thicknesses of the electrode film 104a-b, pressure applied by the calender, desired adhesion strength, and a host of other factors.

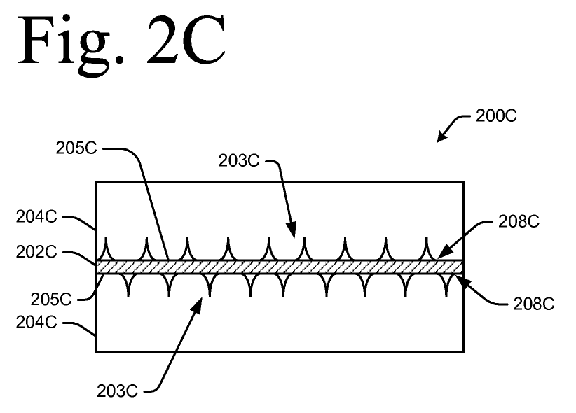

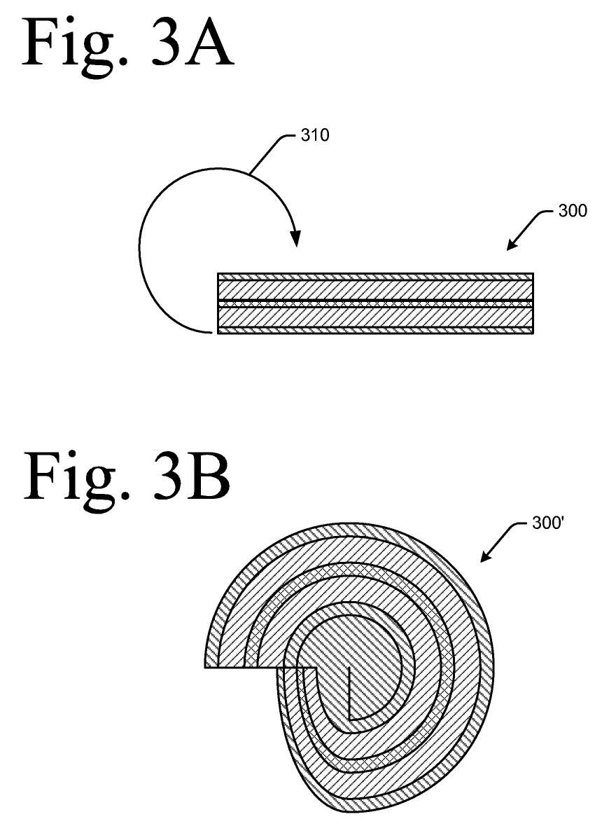

In any event, the electrode may then be cut or otherwise shaped, and terminals may be attached to the current collectors to form various electrode materials and electrode devices, including but not limited to ultra-capacitors, super-capacitors, batteries, and other energy storage devices. In an exemplary embodiment, the electrode may be rolled into a “jelly-roll” configuration for use in various types of capacitive devices. FIGS. 3A and 3B are side views illustrating a rolling process for manufacturing an exemplary electrode device from an electrode. In FIG. 3A, the electrode 300 is shown after the bonding process described above with reference to FIGS. 1A through 2C. The electrode 300 may then be rolled on top of itself in the direction generally illustrated by arrow 310 in FIG. 3A until it forms the “jelly-roll” configuration 300′ shown in FIG. 3B, which may then be fitted with connectors to the current collector for use as a capacitive device, battery, or other energy storage device. The cylindrical configuration increases the amount of capacitance in a tight volume and weighs less than unrolled configurations. Further, the conductive protrusions that extend from the current collectors into the active electrode films reduce the ESR of the electrodes and, correspondingly, the energy storage devices utilizing those electrodes.

In one embodiment, an electrode structure 300 may be rolled (e.g., into a jelly-roll configuration 300′ as shown in FIG. 3B), placed into a container, impregnated with an electrolyte, and sealed to form an energy storage device, such as a double-layer capacitor or a battery. In an alternative embodiment, the electrode structure may be assembled in a stacked configuration, placed into a container, impregnated with electrolyte and sealed to form an energy storage device, such as a double-layer capacitor or battery. In another implementation, a similar electrode structure may be placed into a coin cell container, impregnated with electrolyte, and sealed to form a coin cell energy storage device, such as a double-layer capacitor or a battery. In each of these embodiments, the current collectors are electrically connected to terminals of the energy storage device. Jelly-roll, stacked, and coin cell configurations are examples of well known energy storage device configurations in the art and accordingly will not be described further herein. Other energy storage configurations using the described electrodes and electrode structures are also contemplated, however.

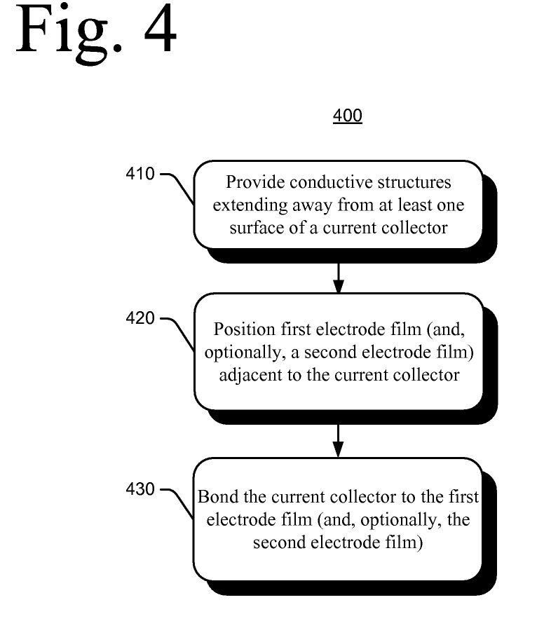

FIG. 4 is a flowchart illustrating exemplary process operations 400 for producing an exemplary electrode. In operation 410, conductive protrusions are provided extending away from at least one surface of a current collector. The conductive protrusions may be formed, for example, by attaching conductive particles to the current collector, forming needles or spikes extending from the surface of the current collector, deforming the surface of the current collector, or in some other manner. In operation 420, a first electrode film (and, optionally, a second electrode film) is positioned adjacent to a current collector. In operation 430, the current collector is bonded to the first electrode film (and, optionally, the second electrode film). The current collector and electrode film(s) may be bonded together, for example, by rolling, calendaring, laminating, or otherwise applying pressure to the current collector and electrode film(s). Accordingly, the process operations 400 represent an example of a completely dry electrode production process. Other processes, such as wet coating processes, may also be used, however.

The inventive methods for manufacturing electrodes and electrode devices (including, but not limited to multi-layer or double-layer capacitors) have been described above in considerable detail. This was done for illustrative purposes. Neither the specific implementations of the invention as a whole, nor those of its features, limit the general principles underlying the invention. In particular, the invention is not necessarily limited to the specific sizes, configurations, or types of materials and proportions of constituent materials used in making the electrodes or electrode devices. The specific features described herein may be used in some implementations, but not in others, without departure from the spirit and scope of the invention as set forth. Many additional modifications are intended in the foregoing disclosure, and it will be appreciated by those of ordinary skill in the art that, in some instances, some features of the invention will be employed in the absence of other features. The illustrative examples therefore do not define the metes and bounds of the invention and the legal protection afforded the invention, which function is served by the claims and their equivalents.

1. An electrode material comprising:
a first electrode; and
a current collector disposed adjacent to and bonded to the first electrode, the current collector comprising a plurality of conductive protrusions extending in a z-direction from the current collector into the first electrode.

2. The electrode material of claim 1 wherein the first electrode comprises a first electrode film.

3. The electrode material of claim 2 further comprising a second electrode film, the current collector disposed between the first electrode film and the second electrode film.

4. The electrode material of claim 3 wherein a second plurality of conductive protrusions extend in a z-direction from the current collector into the second electrode film.

5. The electrode material of claim 1 wherein the first electrode and the current collector are bonded substantially without using an adhesive

6. The electrode material of claim 1 wherein the first electrode and the current collector are bonded without using an adhesive

7. The electrode material of claim 1 wherein the first electrode and the current collector are bonded by applying pressure collectively to the first electrode and the current collector.

8. The electrode material of claim 1 wherein first electrode and the current collector are bonded by applying pressure and heat to the first electrode and the current collector.

9. The electrode material of claim 1 further comprising a non-conductive separator overlayed on the first electrode.

10. The electrode material of claim 1 wherein the electrode material forms an electrode of a double-layer capacitor.

11. The electrode material of claim 1 wherein the conductive protrusions comprise a plurality of conductive particles attached to a surface of the current collector.

12. The electrode material of claim 10 wherein the plurality of conductive particles are sprayed onto the surface of the current collector.

13. The electrode material of claim 10 wherein the plurality of conductive particles are deposited onto the surface of the current collector.

14. The electrode material of claim 10 wherein the plurality of conductive particles comprise aluminum particles.

15. The electrode material of claim 1 wherein the conductive protrusions comprise a plurality of needles extending from a surface of the current collector.

16. The electrode material of claim 1 wherein the conductive protrusions comprise a plurality of spikes extending from a surface of the current collector.

17. The electrode material of claim 1 wherein the conductive protrusions comprise a plurality of deformations formed in the current collector.

18. The electrode material of claim 16 wherein the plurality of deformations are formed by embossing the current collector.

19. The electrode material of claim 16 wherein the plurality of deformations are formed by punching the current collector.

20. A method for producing an electrode material comprising:
positioning a current collector adjacent to a first electrode, the current collector comprising a plurality of conductive protrusions extending in a z-direction from the current collector towards the first electrode; and
bonding the current collector to the first electrode,
wherein the plurality of conductive protrusions extend from the current collector into the first electrode.

21. The method of claim 20 wherein the first electrode comprises a first electrode film.

22. The method of claim 20 wherein the operation of coupling the first electrode film and the second electrode film is performed substantially without using an adhesive.

23. The method of claim 20 wherein the operation of coupling the first electrode film and the second electrode film is performed without using an adhesive.

24. The method of claim 20 wherein each operation is a dry operation.

25. The method of claim 20 wherein the operation of bonding comprises applying pressure to the current collector and the first electrode film.

26. The method of claim 25 wherein the operation of bonding comprises applying heat to enhance a bond between the current collector and the first electrode film.

27. The method of claim 20 further comprising a second electrode film, wherein the current collector is positioned between the first electrode film and the second electrode film and the current collector is bonded to the first electrode film and the second electrode film.

28. The method of claim 27 wherein a second plurality of conductive protrusions extend in a z-direction from the current collector into the second electrode film.

29. The method of claim 20 further comprising positioning a non-conductive separator adjacent to the first electrode film.

30. The method of claim 20 further comprising rolling the first electrode film and the current collector onto itself.

31. A double-layer capacitor produced according to the method of claim 20.

32. A double-layer capacitor device comprising:
a current collector bonded to a first electrode material, the first current collector comprising a plurality of conductive protrusions extending from the current collector into the first electrode material.

33. The double-layer capacitor of claim 30 wherein the current collector is disposed between and bonded to the first electrode material and a second electrode material, the current collector comprising a second plurality of conductive protrusions extending from the current collector into the second electrode material.

34. The double-layer capacitor of claim 30 wherein the current collector is bonded to the first electrode material substantially without an adhesive.

35. The double-layer capacitor of claim 30 wherein the current collector is bonded to the first electrode material without an adhesive.

36. The double-layer capacitor device of claim 30 wherein the conductive protrusions comprise a plurality of conductive particles attached to the current collector.

37. The double-layer capacitor device of claim 30 wherein the conductive protrusions comprise a plurality of needles extending from the current collector.

38. The double-layer capacitor device of claim 30 wherein the conductive protrusions comprise a plurality of spikes extending from the current collector.

39. The double-layer capacitor device of claim 30 wherein the conductive protrusions comprise a plurality of deformations in the current collector.

40. The double-layer capacitor device of claim 20 wherein the first electrode material comprises an electrode film.
